(19) United States
(12) Patent Application Publication
(10) Pub. No.: US 2025/0199227 A1
(43) Pub. Date: Jun. 19, 2025

(54) VHOE-FORMING ANGLE-MULTIPLEXING RECORDING SYSTEM WITH ROTATING GRATING

(71) Applicant: NATIONAL CENTRAL UNIVERSITY, Taoyuan City (TW)

(72) Inventors: Wen-Kai LIN, Taoyuan City (TW); Shao-Kui ZHOU, Taoyuan City (TW); Wei-Chia SU, Taoyuan City (TW); Ching-Cherng SUN, Taoyuan City (TW); Shiuan-Huei LIN, Taoyuan City (TW); Yeh-Wei YU, Taoyuan City (TW); Tsung-Hsun YANG, Taoyuan City (TW)

(21) Appl. No.: 18/601,890

(22) Filed: Mar. 11, 2024

(30) Foreign Application Priority Data
Dec. 18, 2023 (TW) 112149337

(51) Int. Cl. G02B 5/32; G02B 5/18; G02B 27/01

(52) U.S. Cl. CPC G02B 5/32; G02B 5/1828; G02B 27/0172; G02B 2027/0174

(57) ABSTRACT

A VHOE (volume holographic optical element)-forming angle-multiplexing recording system with a rotating grating includes a collimated light source and an electronic iris in addition to the rotating grating. The rotating grating is provided in the optical path of the collimated light source and has a light output surface serving also as a placement surface on which a volume-hologram-recording photosensitive material can be placed. The electronic iris is provided in the optical path between the collimated light source and the rotating grating. The VHOE-forming angle-multiplexing recording system is easy to operate, is stable, and can make a plurality of gratings without generating a ghost image.

### BACKGROUND OF THE INVENTION

### 1. Technical Field

The present invention relates to a VHOE (volume holographic optical element)-forming angle-multiplexing recording system with a rotating grating. More particularly, the invention relates to an angle-multiplexing recording system that has a rotating grating, that is configured to form a VHOE, and that uses angle multiplexing to increase the viewing angle provided by the VHOE.

### 2. Description of Related Art

Referring to FIG. 1, a conventional VHOE-based light-guide near-eye display P100 includes R (red), G (green), and B (blue) light guides R1, G1, and B1; input-end VHOEs P11; and output-end VHOEs P12. The information light of a display panel P13 is projected through a protective lens P14 into the input-end VHOEs P11 and is diffracted and coupled into the R, G, and B light guides R1, G1, and B1 by the input-end VHOEs P11.

Afterward, the information light is transmitted through the R, G, and B light guides R1, G1, and B1 under total reflection conditions, is diffracted and coupled out of the light guides by the output-end VHOEs P12, and is eventually transmitted to a human eye P15 so that the viewer can obtain the corresponding image information. As a VHOE has strong angle selectivity, the viewing angle provided by a single-structure VHOE is highly limited and must be increased by angle multiplexing.

FIG. 2 shows a conventional two-time angle-multiplexing recording structure P200. The light of a coherent light source P21 passes through a spatial filter SF and a collimating lens CL and is thereby turned into a highly directive collimated light beam, which in turn goes through a number of beam splitters BS and is split into four collimated light beams under the action of a number of shutters and a number of reflective mirrors M.

The four collimated light beams interfere in a predetermined manner in a volume-hologram-recording photosensitive material 40 under the action of a prism P22. The first grating is made with first object light, whose angle of incidence is θ_{PS1}, and first reference light, whose angle of incidence is θ_{PR1}. The second grating is made with second object light, whose angle of incidence is θ_{PS2}, and second reference light, whose angle of incidence is θ_{PR2}. The recording process requires the use of an electronic iris to ensure that the collimated light beams for making the first grating and the collimated light beams for making the second grating do not interfere with each other.

FIG. 3 shows information light striking a VHOE having a grating vector K. The incident light k₁ has a light vector k_{1,x}. The diffracted light k₂ has an x-axis component k_{2,x} that can be expressed as:

$${k}_{2 , x} = {k}_{1 , x} - {K}_{x}$$

where Kₓ is the x-axis component of the grating vector K. The y-axis component k_{2,y} of k₂ can be expressed as:

$${k}_{2 , y} = {k}_{1 , y} - {K}_{y}$$

where K_{y} is the y-axis component of the grating vector K. The z-axis component of the diffracted light k₂ is:

$${k}_{2 , z} = \sqrt{{( n \frac{2 π}{{λ}_{0}} )}^{2} - {k}_{2 , x}^{2} - {k}_{2 , y}^{2}}$$

where: n is the refractive index of the medium, and λ₀ is the wavelength of the information light in vacuum.

It can be known from the above that when the x-axis component Kₓ or the y-axis component K_{y} of the grating vector is changed, the components k_{2,x} and k_{2,y} of the diffracted light vector will also be changed, meaning the angle of diffraction of the diffracted light will change with the components of the vector K that are defined along the surface of incidence.

Taking the recording structure in FIG. 2 for example, and assuming the grating vector component K_{y}=0, the grating structures recorded by two-time angle multiplexing are shown in FIG. 4. In order for any information light incident on the two gratings to be diffracted into a waveguide at the same angle, the grating vectors of the two gratings must have the same x-axis components Kₓ. That is to say, the periods Λₓ of the gratings (which periods are defined as parallel to the surface of the volume-hologram-recording photosensitive material 40) must be the same as the x-axis components Kₓ of the grating vectors, or a light beam will be diffracted in two directions, causing a ghost image.

To meet the above conditions, the angle of incidence of the first object light, Λ_{PS1}, and the angle of incidence of the first reference light, θ_{PR1}, must be precisely controlled in the recording system of FIG. 2, and so must the angle of incidence of the second object light, θ_{PS2}, and the angle of incidence of the second reference light, θ_{PR2}. Moreover, if it is desired to record N gratings in the volume-hologram-recording photosensitive material 40, angle multiplexing must be performed for N times, and the recording system must be provided with optical elements capable of generating 2N collimated light beams, with the angle of each optical element set with very high precision. This configuration, however, results in inefficient use of optical energy and makes it difficult to prevent ghost images completely when performing angle multiplexing on a common volume-hologram-recording photosensitive material 40 for multiple times.

### SUMMARY OF THE INVENTION

The present invention is directed to a VHOE-forming angle-multiplexing recording system with a rotating grating. The recording system is intended mainly to solve the problem of how to form a VHOE by recording multiple gratings in a volume-hologram-recording photosensitive material (i.e., a photosensitive material for forming the VHOE) using the simplest and the most stable and precise VHOE-forming angle-multiplexing recording system while preventing the generation of ghost images.

The present invention provides a VHOE-forming angle-multiplexing recording system with a rotating grating. The recording system includes: at least one collimated light source, a rotating grating provided in the optical path of the collimated light source and having a light output surface serving also as a placement surface on which a volume-hologram-recording photosensitive material is placed, and an electronic iris provided in the optical path between the collimated light source and the rotating grating.

Implementation of the present invention at least produces the following advantageous effects:
1. Ghost images can be effectively prevented when making multiple volume gratings.
2. Compared with the prior art, the recording system of the present invention is simpler and more stable and can produce VHOE products with gratings recorded with higher precision.
3. The recording system of the present invention can reduce the defective rate of products and increase production efficiency while lowering the production cost.

### BRIEF DESCRIPTION OF THE DRAWINGS

The structure and the technical means adopted by the present invention to achieve the above and other objectives can be best understood by referring to the following detailed description of a preferred embodiment and the accompanying drawings, wherein:

FIG. 1 schematically shows a conventional light-guide near-eye display based on volume holographic optical elements;

FIG. 2 shows a conventional recording structure that performs angle multiplexing twice on a volume-hologram-recording photosensitive material;

FIG. 3 schematically shows the relationship between light incident on a volume holographic optical element and the resulting diffracted light;

FIG. 4 shows the grating structures formed in a volume holographic optical element by performing angle multiplexing twice;

FIG. 5A is a top view of the recording system according to an embodiment of the present invention, showing the optical path in a first recording operation performed at a first angle;

FIG. 5B is another top view of the recording system in FIG. 5A, showing the optical path in a second recording operation performed at a second angle;

FIG. 5C is a side view of the recording system shown in FIG. 5A and FIG. 5B;

FIG. 6A is a graph showing the diffraction efficiency distribution of a volume holographic optical element formed without multiplexing;

FIG. 6B is a graph showing the diffraction efficiency distribution of a volume holographic optical element formed by performing multiplexing for nine times;

FIG. 7A shows a laser-backlit image transmitted through a volume holographic optical element formed by performing angle multiplexing for nine times; and

FIG. 7B shows an LED-backlit image transmitted through a volume holographic optical element formed by performing angle multiplexing for nine times.

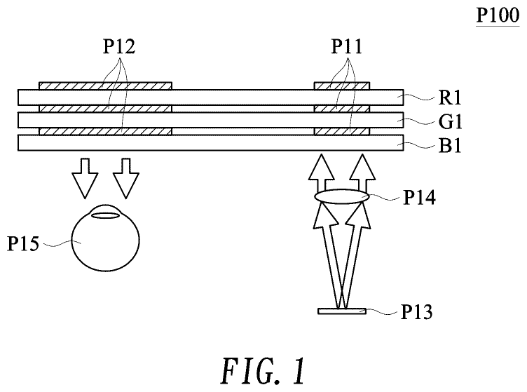

### DETAILED DESCRIPTION OF THE INVENTION

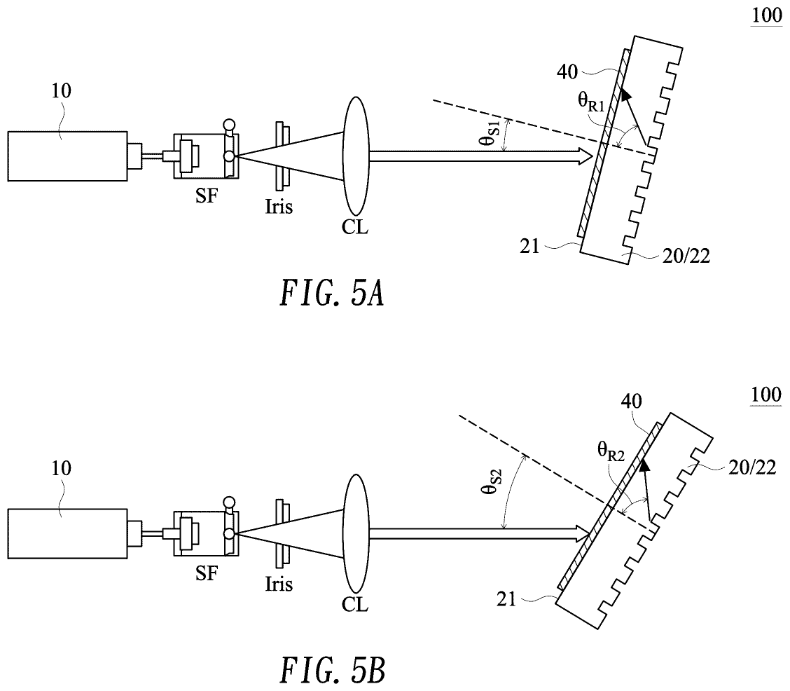

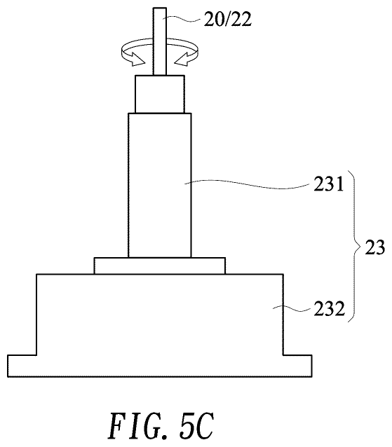

The embodiment shown in FIG. 5A to FIG. 5C is a VHOE-forming angle-multiplexing recording system 100 with a rotating grating, hereinafter referred to as the VHOE-forming angle-multiplexing recording system 100 for short. The VHOE-forming angle-multiplexing recording system 100 includes at least one collimated light source 10, a rotating grating 20, and an electronic iris Iris.

A portion of the light emitted by the collimated light source 10 forms object light while another portion of the light of the collimated light source 10 forms reference light under the action of the rotating grating 20.

The rotating grating 20 is provided in the optical path of the collimated light source 10. The rotating grating 20 has a light output surface that doubles as a placement surface 21 on which a volume-hologram-recording photosensitive material 40 is placed. The rotating grating 20 may be a thin grating 22 (e.g., a Raman-Nath grating) having a rotary supporting unit 23 for supporting and rotating the thin grating 22. More specifically, the rotary supporting unit 23 may include: a support 231 for supporting and rotating the thin grating 22, and a motor 232 for driving the support 231 into rotation.

The volume-hologram-recording photosensitive material 40 is a photosensitive material to which light will be projected. As the light output surface, i.e., the placement surface 21, of the rotating grating 20 is a flat surface, the volume-hologram-recording photosensitive material 40 is compliantly attached to the light output surface of the rotating grating 20.

Referring to FIG. 5A and FIG. 5C, when a first collimated light beam of the collimated light source 10 is projected to the rotating grating 20 in a first recording operation, the rotating grating 20 is rotated to a first angle such that the first collimated light beam, i.e., the first object light, enters the volume-hologram-recording photosensitive material 40 at a first-collimated-light-beam angle of incidence, θ_{S1}, is diffracted at the far end of the thin grating 22, and is thereby turned into the corresponding first diffracted light, i.e., the first reference light, which has a first-diffracted-light angle of incidence, θ_{R1}. The first diffracted light and the first collimated light beam interfere with each other, forming a first recorded grating that is recorded in the volume-hologram-recording photosensitive material 40.

Referring to FIG. 5B and FIG. 5C, when a second collimated light beam of the collimated light source 10 is projected to the VHOE-forming angle-multiplexing recording system 100 with a rotating grating in a second recording operation, the rotating grating 20 is rotated to a second angle such that the second collimated light beam, i.e., the second object light, enters the volume-hologram-recording photosensitive material 40 at a second-collimated-light-beam angle of incidence, θ_{S2}, is diffracted at the far end of the thin grating 22, and is thereby turned into the corresponding second diffracted light, i.e., the second reference light, which has a second-diffracted-light angle of incidence, θ_{R2}. The second diffracted light and the second collimated light beam interfere with each other, forming a second recorded grating that is also recorded in the volume-hologram-recording photosensitive material 40.

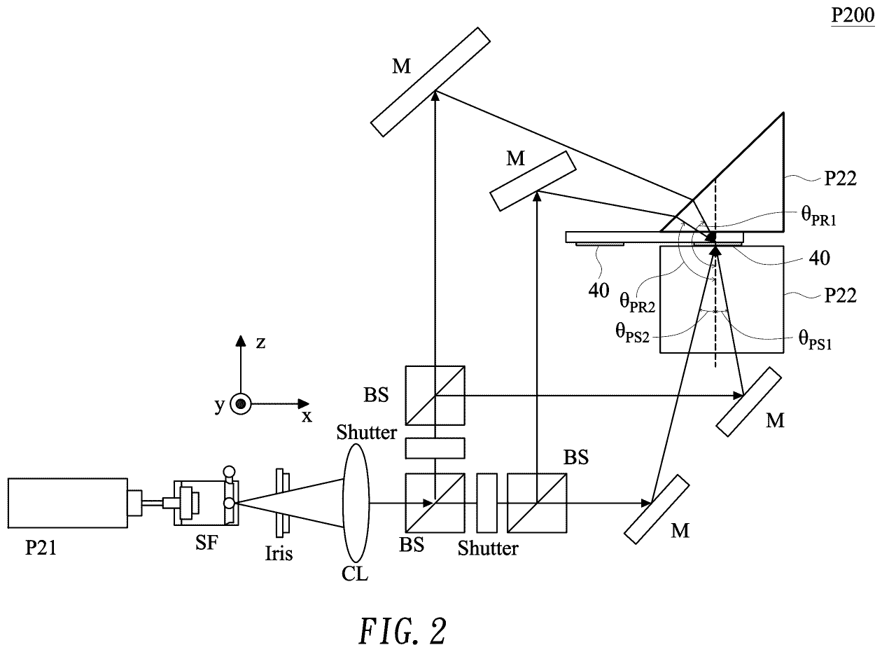

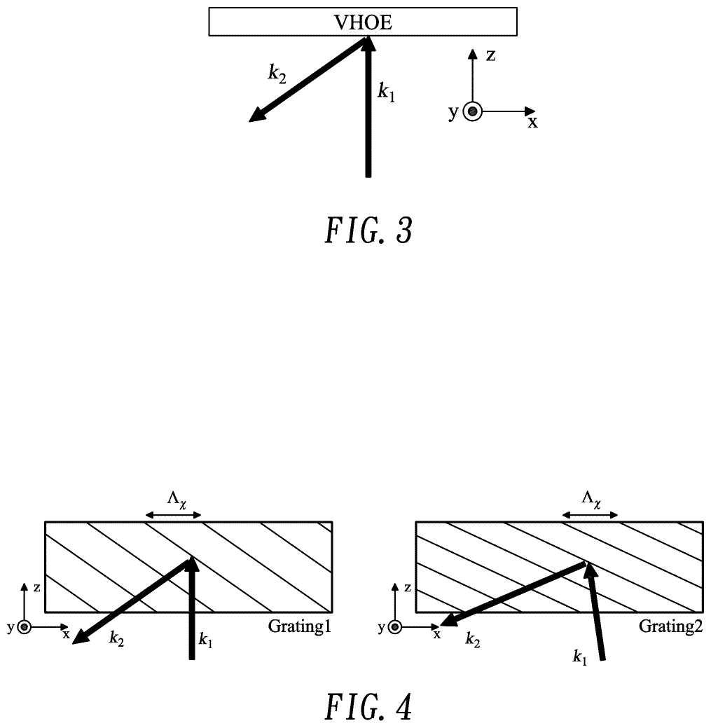

Thanks to the foregoing system structure and recording method, the recording structure in this embodiment is more precise, simpler, and easier-to-maintain than the prior art. The first collimated light beam and the first diffracted light in this embodiment work in place of the first object light and the first reference light in FIG. 2 respectively, and the second collimated light beam and the second diffracted light in this embodiment work in place of the second object light and the second reference light in FIG. 2 respectively.

The electronic iris Iris is provided in the optical path between the collimated light source 10 and the rotating grating 20. The electronic iris Iris serves mainly to ensure that the first collimated light beam, which is used when the rotating grating 20 is at the first angle, i.e., θ_{S1}, and the second collimated light beam, which is used when the rotating grating 20 is at the second angle, i.e., θ_{S2}, do not interfere with each other.

The collimated light source 10 may be a laser light source, with a spatial filter SF provided between the laser light source and the electronic iris Iris, and a collimating lens CL provided between the electronic iris Iris and the rotating grating 20. After passing through the spatial filter SF and the collimating lens CL, the light of the laser light source will be turned into a highly directive collimated light beam.

When this embodiment is put into use, N recorded gratings can be formed by multiplexing, or more particularly by directly rotating the rotating grating 20 for N times, without having to use any additional optical element. When a collimated light beam enters the thin grating 22, the relationship between the angle of incidence and the angle of diffraction can be expressed as:

$$n sin ( {θ}_{d} ) = \frac{{λ}_{0}}{{Λ}_{0}} + sin ( {θ}_{i} ) \qquad ( 4 )$$

where: n is the refractive index of the medium, θ_{d} is the angle of diffraction of the diffracted light in the medium, λ₀ is the wavelength of the incident collimated light beam in vacuum, Λ₀ is the period of the thin grating, and Λᵢ is the angle of incidence of the incident collimated light beam in air. When the diffracted light and the incident collimated light beam interfere with each other in the volume-hologram-recording photosensitive material 40, the resulting recorded grating has a horizontal component Kₓ:

$${K}_{x} = \frac{2 π}{{Λ}_{x}} = \frac{2 π}{{λ}_{0}} sin ( {θ}_{i} ) - n \frac{2 π}{{λ}_{0}} sin ( {θ}_{d} ) \qquad ( 5 )$$

where Λₓ is the period of the surface of the photosensitive material.

Therefore, a VHOE with a grating recorded by the recording method of this embodiment has a period Λₓ parallel to the surface of incidence:

$${Λ}_{x} = \vert \frac{{λ}_{0}}{sin ( {θ}_{i} ) - n sin ( {θ}_{d} )} \vert . \qquad ( 6 )$$

By substituting formula (4) into formula (6), the period of the VHOE that is parallel to its surface can be rewritten as:

$${Λ}_{x} = {Λ}_{0} . \qquad ( 7 )$$

That is to say, regardless of the angle of incidence of the incident collimated light beam, the incident collimated light beam and the corresponding diffracted light will generate a grating vector whose component along the surface of incidence is bound to be the same as the surface component of the grating vector of the thin grating 22. Therefore, by rotating the thin grating 22 in this embodiment, angle multiplexing can be carried out multiple times. This allows production cost as well as the difficulty of system installation to be significantly reduced.

Besides, each pair of object light and reference light in this embodiment have so small an optical path difference that they practically share a common path. In consequence, the VHOE-forming angle-multiplexing recording system 100 has far less stringent requirements regarding system vibrations and stability than the conventional recording structure P100. This embodiment also allows a plurality of collimated light sources 10 to be provided to produce a plurality of collimated light beams that are sequentially projected to reduce the required number of times of rotation and the required process time.

To verify the advantageous effects of this embodiment, an experiment was conducted with a 16 μm-thick VHOE material, a thin grating 22 having a period of 370 nm, and a coherent light source whose light has a 457 nm wavelength. Angle multiplexing was performed by changing the angle of incidence from −14° to −10.5°, −7°, −3.5°, 0°, 3.5°, 7°, 10.5°, and 14°.

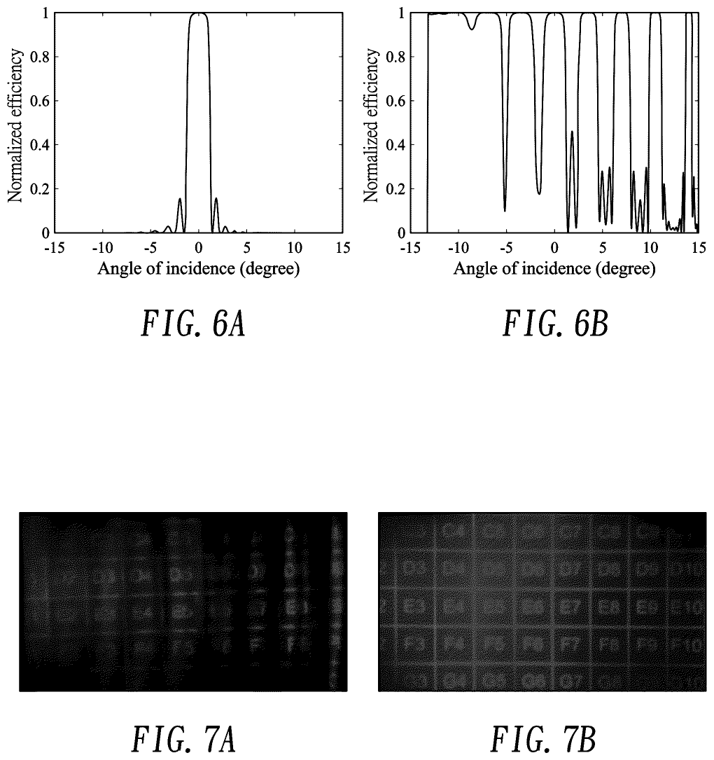

FIG. 6A and FIG. 6B show the results of an analysis based on the coupled wave theory and intended to find the difference between a structure formed by multiplexing and a structure formed without multiplexing, with the reconstructed light source being a coherent light source whose light had a 457 nm wavelength, and the refractive index modulation set at 0.02. After efficiency normalization, it can be clearly seen in FIG. 6A and FIG. 6B that the angles of incidence of the light diffracted by the structure formed by performing multiplexing for nine times (FIG. 6B) are several times as many as the angle of incidence of the light diffracted by the structure formed without multiplexing (FIG. 6A).

FIG. 7A and FIG. 7B show images, or image information, delivered to the human eye through a diffractive light guide composed of a volume holographic optical element formed by performing multiplexing for nine times according to the method described above. The image information is +15°. The image result shown in FIG. 7A was obtained by using a 457 nm laser as the light source, matches the simulation result, and does not include any ghost image. The image result shown in FIG. 7B was obtained by using a blue LED as the light source and does not include any ghost image, either.

The above description is based on only a preferred embodiment of the present invention and is not intended to limit the invention in any way. Although the invention has been disclosed above by way of the preferred embodiment, the embodiment is not intended to limit the invention. A person skilled in the relevant art will recognize that equivalent embodiments can be achieved by modifying, varying, or making equivalent changes to the disclosed embodiment without departing from the scope of the technical solution of the invention. Any simple modification or equivalent change that is made to the above embodiment according to the material contents of the invention shall be regarded as falling within the scope of the technical solution of the invention.

What is claimed is:

1. A VHOE (volume holographic optical element)-forming angle-multiplexing recording system with a rotating grating, comprising:
at least one collimated light source;
the rotating grating, which is provided in an optical path of the collimated light source, the rotating grating having a light output surface serving also as a placement surface on which a volume-hologram-recording photosensitive material is placed; and
an electronic iris provided in the optical path between the collimated light source and the rotating grating.

2. The VHOE-forming angle-multiplexing recording system as claimed in claim 1, wherein the collimated light source is a laser light source, a spatial filter is provided between the laser light source and the electronic iris, and a collimating lens is provided between the electronic iris and the rotating grating.

3. The VHOE-forming angle-multiplexing recording system as claimed in claim 1, wherein the rotating grating is a thin grating, and the thin grating has a rotary supporting unit for supporting and rotating the thin grating.

4. The VHOE-forming angle-multiplexing recording system as claimed in claim 3, wherein the rotary supporting unit comprises a support for supporting the thin grating and a motor for driving the support into rotation.

5. The VHOE-forming angle-multiplexing recording system as claimed in claim 1, wherein the at least one collimated light source is a plurality of collimated light beams, and the collimated light beams are sequentially projected.
